(19) United States
(12) Patent Application Publication
(10) Pub. No.: US 2019/0323476 A1
(43) Pub. Date: Oct. 24, 2019

(54) SPARK DISCHARGE IGNITION PROMOTING METHOD, SPARK DISCHARGE IGNITION PROMOTING APPARATUS, AND ENGINE WITH SPARK DISCHARGE IGNITION PROMOTING APPARATUS

(71) Applicant: National Institute of Advanced Industrial Science and Technology, Chiyoda-ku, Tokyo (JP)

(72) Inventors: Eiichi Takahashi, Ibaraki (JP); Takehiko Segawa, Ibaraki (JP)

(21) Appl. No.: 15/774,460

(22) PCT Filed: Nov. 9, 2016
(86) PCT No.: PCT/JP2016/083246

§ 371 Date: May 8, 2018

(30) Foreign Application Priority Data
Nov. 9, 2015 (JP) 2015-219289

(51) Int. Cl. F02P 5/15; F02P 3/01; F02B 23/08; F02P 15/02; F02P 15/10; F02P 9/00

(52) U.S. Cl. CPC F02P 5/15; F02P 3/01; F02B 23/08; H01T 13/22; F02P 15/10; F02P 9/007; F02P 15/02

(57) ABSTRACT

Stable combustion becomes possible even in a super-lean combustion engine or an engine that carries out a large amount of EGR. In a spark discharge ignition promoting apparatus, non-thermal plasma is generated in a cylinder by a non-thermal plasma generating unit. The non-thermal plasma generating unit is provided at a location where a processed air-fuel mixture by the non-thermal plasma reaches a spark plug after an in-cylinder flow or where the air-fuel mixture exists around an electrode of the spark plug in a time when the air-fuel mixture keeps an easy combustion state. The spark plug ignites the processed air-fuel mixture by discharge of the spark plug at timing when the processed air-fuel mixture by the non-thermal plasma of an easy combustion state reaches the spark plug after an in-cylinder flow or timing when the air-fuel mixture of the easy combustion state exists around an electrode of the spark plug in the time when the air-fuel mixture keeps the easy combustion state.

### CROSS-REFERENCE TO RELATED APPLICATIONS

This application is a National Stage application of International Patent Application No. PCT/JP2016/083246, filed on Nov. 9, 2016, which claims priority to Japanese Patent Application No. 2015-219289, filed on Nov. 9, 2015, each of which is hereby incorporated by reference in its entirety.

### TECHNICAL FIELD

The present invention relates to a spark discharge ignition promoting method, a spark discharge ignition promoting apparatus, and an engine with the spark discharge ignition promoting apparatus. More particularly, the present invention relates to a technique effective for a super lean combustion engine or promotion of spark discharge ignition in an engine that carries out a large amount of EGR.

### BACKGROUND ART

In recent years, improvement of fuel efficiency of an engine, which includes a gasoline engine for a vehicle, in a premixing combustion method has become the strongest theme. It is effective to reduce pumping loss as much as possible in view of combustion efficiency by making an air-fuel ratio super lean or carrying out super dilution by a large amount of EGR or the like.

Namely, in view of energy saving and discharge of low nitrogen oxide, an engine that operates by making an air-fuel mixture lean/dilution or super lean/super dilution is desired.

However, in a case where the air-fuel ratio is made super lean or super dilution is carried out by recirculating a large amount of exhaust gas to a combustion chamber, there has been a problem that combustion becomes unstable and not only an intended output cannot be exerted, but also fuel efficiency is deteriorated due to misfire.

### (Ignition by Spark Plug)

A configuration in an engine that ignites by a spark plug is that only the spark plug is provided in a combustion chamber of a cylinder as igniting means (for example, see Internal Combustion Engine Fundamentals, J. B. Heywood). As an operation of ignition, spark by the spark plug is generated in an air-fuel mixture compressing process to ignite.

The spark by the spark plug is thermal plasma. In the thermal plasma, both ion temperature and electron temperature are high temperature (from several thousand ° C. to ten thousand ° C.). High ion temperature is mainly used for the ignition as the action.

The ignition by the spark plug, which is conventional igniting means becomes unstable in a case where a lean/dilution air-fuel mixture is used. Thus, it is hard to ignite. Namely, a problem that the engine cannot be operated by the air-fuel mixture in a lean/dilution region occurs.

Japanese Patent Application Publication No. H11-2158) describes that an introductory portion for recirculation exhaust is provided downstream a swirl control valve provided on an intake passage, and lean combustion is possible by distributing the recirculation exhaust at thick air-fuel mixture portion in the center of a combustion chamber. Japanese Patent Application Publication No. 2002-115549 describes that fuel is injected into a cavity that is formed on an upper surface of a piston, and a stratified mixture is guided to a vicinity of a spark plug. However, even though the recirculation exhaust is distributed at the thick air-fuel mixture portion in the center of the combustion chamber or the stratified mixture is guided to the vicinity of the spark plug, there is a limit to make the air-fuel mixture lean and an operational region in which lean air-fuel mixture is available is also limited.

### (Diesel Engine)

A spark plug or the like is not provided in a diesel engine. It has a configuration in which a fuel injector is provided (for example, see Internal Combustion Engine Fundamentals, J. B. Heywood). As an operation of ignition, fuel is injected into air whose temperature is raised by high adiabatic compression (pressurization) to ignite. The diesel engine is an engine of an alternate form with respect to the engine for the premixing combustion method because of diffusion combustion.

### (Ignition by Only Non-Thermal Plasma)

Japanese Patent Application Publication No. 2014-107198 discloses an engine ignition technique of a mixed combustion method having a configuration in which only generating means for generating non-thermal plasma is provided in a combustion chamber of a cylinder, but a spark plug or the like is not provided therein. However, ion temperature during the non-thermal plasma is temperature far lower than that in spark. The non-thermal plasma is also called as low temperature plasma or non-thermal equilibrium plasma. As the non-thermal plasma, there are dielectric barrier discharge, streamer, discharge of a microwave, and the like.

Local high-temperature ignition is used in the spark plug. On the other hand, in ignition by only the non-thermal plasma, plasma is generated in a wide region to realize voluminous ignition for an air-fuel mixture whose temperature is raised by adiabatic compression (pressurization).

In an ignition method by the spark plug, ignition is carried out by only generating means for generating the plasma in the combustion chamber of the cylinder. Even though the ignition method by only non-thermal plasma can cause an engine to operate by using a lean/dilution air-fuel mixture, supplied electric power is large by applying high voltage. For this reason, an electrode of the means for generating the plasma is susceptible to be damaged, and there has been a problem that a life of the electrode is short.

Further, generation efficiency of radicals is poor, and electric power consumption is large. Since a large power source is required for formation of voluminous plasma, there has been a problem that the whole apparatus provided with the generating means for generating the plasma becomes large.

For example, a technique disclosed in Japanese Patent Application Publication No. 2015-055224 is also ignition of only non-thermal plasma. However, it is different from the non-thermal plasma ignition described above. Japanese Patent Application Publication No. 2015-055224 describes a technique in which temperature of premixed fuel that is processed by plasma in an intake pipe is raised by adiabatic compression of a piston to ignite. This is a technique intended for a Homogeneous Charge Compression Ignition (HCCI) engine, which is another type of engine. There is a drawback that a precise control for ignition timing is difficult in the HCCI engine.

Inventors of the present application filed Japanese Patent Application No. 2015-542682 as prior art of an earlier application. This application describes a configuration of an internal-combustion engine for a conventional premixing combustion method in which a spark plug is provided in a combustion chamber of a cylinder. In the configuration, a non-thermal equilibrium plasma generating apparatus is further provided in an air-fuel mixture supplying system to an intake port.

It is a technique in which premixed fuel of an easy ignition state, which is generated by the non-thermal equilibrium plasma generating apparatus in the air-fuel mixture supplying system to the intake port, is sucked into the combustion chamber of the cylinder.

In an easy ignition region generated by the non-thermal equilibrium plasma generating apparatus in the air-fuel mixture supplying system to the intake port, partial oxides and the like are generated after radicals and the like are generated. In an air-fuel mixture region containing these, it becomes easy to ignite by means of spark by the spark plug in the combustion chamber compared with the original air-fuel mixture.

However, there is no effect of the ignition for a lean air-fuel mixture unless the partial oxides and the like with a prescribed concentration are contained therein. The application described above provides the non-thermal equilibrium plasma generating apparatus in the air-fuel mixture supplying system to the intake port. Therefore, there is a merit for ease of installation and the like. However, the air-fuel mixture containing the partial oxides and the like are mixed and diffused due to sucking to the spark plug and a concentration of the partial oxides becomes diluted, whereby ease of ignition against lean air-fuel mixture ignition cannot be obtained.

In order to prevent this, almost of the intake air-fuel mixture must be reformed over a large volume by plasma so as to contain the partial oxides and the like described above with the prescribed concentration to facilitate the lean air-fuel mixture ignition.

In order to do so, there is a problem that energy consumption must become large and generating means for generating plasma must also become large. Moreover, by subjecting almost all of the air-fuel mixture to non-thermal plasma treatment, abnormal ignition readily occurs. To the contrary, there is concern that knocking occurs.

As described above, there have been many problems to realize a lean/dilution or super lean/super dilution combustion engine by the prior art.

### SUMMARY

It is thus an object of the present invention to provide a spark discharge ignition promoting apparatus, an engine with the spark discharge ignition promoting apparatus, and a spark discharge ignition promote method capable of surely and stably igniting, making energy saving in ignition, making a life of the apparatus longer, and realizing the apparatus at low cost and with relatively compact size, in order to realize an engine, which operates even in a lean or super-lean air-fuel mixture, in a premixing combustion method.

The foregoing and other objects, and new features of the present invention will become more apparent from the detailed description of the present specification and the appending drawings.

The inventors of the present application thought that a method using a spark plug is essential for accuracy of a control of ignition timing and sure ignition. On the other hand, reforming an air-fuel mixture is essential in order to surely ignite with lean or super lean and non-thermal plasma treatment is best therefor. As a result of earnest studies for a combustion technique in the prior art, it became apparent that the reformed air-fuel mixture in an easy combustion region does not reach an electrode of the spark plug at ignition timing or the air-fuel mixture in the easy combustion region does not reach it while keeping an easy combustion state, and it led to the present invention.

For example, as described above, in the method disclosed in Japanese Patent Application No. 2015-542682, it was found that it is actually difficult to avoid diffusion of a premixed fuel processed by formation of non-thermal plasma in a conventional intake pipe and cause the premixed fuel to concentrate in the vicinity of a spark plug by means of a flow after an intake valve is closed.

Therefore, it is essential solution for promotion of ignition to grasp a change after the non-thermal plasma treatment for the air-fuel mixture and to carry out ignition in which its easy ignitibility is employed.

Generally, the non-thermal plasma has a feature that electron temperature (from tens of thousands ° C. to hundreds of thousands ° C.) is high, but ion temperature is lower than the electron temperature by two orders or more. Generating means thereof is generated by dielectric barrier discharge, streamer, microwave discharge, or the like. In the non-thermal plasma treatment for the air-fuel mixture, the following situations occur.

After radicals and the like are generated by a relaxation process in the plasma immediately after the non-thermal plasma is generated, reaction proceeds from the radicals until a time of about 100 microseconds to generate partial oxides, whereby a region with a combustible state by compression is generated. Metastable chemical species thus formed such as partial oxides have a life of about several seconds. If it does not become appropriate temperature and an appropriate pressure state, an easy combustion characteristic is lost.

Properties of the air-fuel mixture in the easy combustion region are actually lost even due to an air flow by means of mixing, diffusion or the like when it is sent together with a normal air-fuel mixture, whereby it does not lead to stable combustion.

Namely, it is difficult to operate the lean or super lean engine described above by mere combination of the non-thermal plasma and the spark plug.

In order to solve the above problems, timing of the non-thermal plasma treatment and the plug ignition and selection of a location of the spark plug and the non-thermal plasma become keys of the techniques.

Namely, means for solving the problems is as follows.

(1) A spark discharge ignition promoting method including: generating non-thermal plasma in a vicinity of a spark plug or in a region including the spark plug in a cylinder, for an air-fuel mixture compressing process of an engine that uses premixed fuel; and igniting a processed air-fuel mixture by discharge of the spark plug at timing when the processed air-fuel mixture by the non-thermal plasma of an easy combustion state reaches the spark plug after an in-cylinder flow or timing when the air-fuel mixture of the easy combustion state exists around an electrode of the spark plug in a time when the air-fuel mixture keeps the easy combustion state.

(2) The above spark discharge ignition promoting method, wherein a location at which the non-thermal plasma is generated is in a half or lower of a cylinder radius from the spark plug.

(3) The above spark discharge ignition promoting method, wherein an area in the cylinder in which the non-thermal plasma is generated is from 1 cm² or more to 10 cm².

(4) The above spark discharge ignition promoting method, wherein the in-cylinder flow is a flow by a piston motion and/or a non-thermal plasma induced flow.

(5) The above spark discharge ignition promoting method, wherein a time from generation of the non-thermal plasma to plug ignition is from 0.1 ms or more to 20 ms.

(6) A spark discharge ignition promoting apparatus wherein non-thermal plasma is generated in a cylinder by a non-thermal plasma generating unit, wherein the non-thermal plasma generating unit is provided at a location where a processed air-fuel mixture by the non-thermal plasma reaches a spark plug after an in-cylinder flow or where the air-fuel mixture exists around an electrode of the spark plug in a time when the air-fuel mixture keeps an easy combustion state, and wherein the spark plug ignites the processed air-fuel mixture by discharge of the spark plug at timing when the processed air-fuel mixture by the non-thermal plasma of an easy combustion state reaches the spark plug after an in-cylinder flow or timing when the air-fuel mixture of the easy combustion state exists around an electrode of the spark plug in the time when the air-fuel mixture keeps the easy combustion state.

(7) The spark discharge ignition promoting apparatus, wherein the non-thermal plasma generating unit is provided at a location in a distance of a half or lower of a cylinder radius from the spark plug.

(8) The spark discharge ignition promoting apparatus, wherein an area in the cylinder in which the non-thermal plasma is generated by the non-thermal plasma generating unit is from 1 cm² or more to 10 cm².

(9) The spark discharge ignition promoting apparatus, wherein the in-cylinder flow is a flow by a piston motion and/or a non-thermal plasma induced flow.

(10) The spark discharge ignition promoting apparatus, wherein a time to ignite by the discharge of the spark plug at timing when the processed air-fuel mixture by the non-thermal plasma of the easy combustion state reaches the spark plug after the in-cylinder flow or timing when the air-fuel mixture of the easy combustion state exists around the electrode of the spark plug in the time when the air-fuel mixture keeps the easy combustion state is from 0.1 ms or more to 20 ms since the non-thermal plasma was generated.

(11) An engine with a spark discharge ignition promoting apparatus, wherein the engine has the spark discharge ignition promoting apparatus according to any one of the (6) to (10) described above.

Effects obtained by representative one of the inventions disclosed in the present application will be described simply as follows.

(1) It is possible to ignite surely and stably even in the case of a lean air-fuel mixture or a super lean air-fuel mixture.

(2) It is possible to ignite with energy conservation.

(3) It is possible to make a life of the apparatus longer.

(4) It is possible to realize the apparatus at low cost.

### BRIEF DESCRIPTIONS OF THE DRAWINGS

FIG. 1 is a view showing the whole configuration according to the first embodiment.

FIG. 2 is a view of an ignition promoting apparatus according to the first embodiment when viewed from a combustion chamber side.

FIG. 3 is a view showing a relationship between a spark plug and the ignition promoting apparatus.

FIG. 4 is a view showing a cross-section drawing and electric connection of the ignition promoting apparatus.

FIG. 5 is a view showing an outline of a second embodiment.

FIG. 6 is a view showing a relationship of ignition timing of a spark plug, discharge timing by an ignition promoting apparatus, and discharge duration.

FIG. 7 is a view showing an outline of an experiment for examining effects of non-thermal plasma treatment for air-fuel mixture.

FIG. 8 is a view showing experimental data regarding a pressure history.

FIG. 9 is a view showing a result of Schlieren measurement in a case where a reactor of the ignition promoting apparatus is not operated in experimental equipment.

FIG. 10 is a view showing a result of Schlieren measurement in a case where the reactor of the ignition promoting apparatus is operated in the experimental equipment.

FIG. 11 is a view showing the whole configuration in a case where the ignition promoting apparatus is mounted in a four-cylinder engine.

### DETAILED DESCRIPTION

### (Outline)

(1) Non-thermal plasma is generated in a cylinder by a non-thermal plasma generating unit; the non-thermal plasma generating unit configured to generate the non-thermal plasma at a location (in which plasma exists by making retroactive time) in order for a processed air-fuel mixture by the non-thermal plasma to reach a spark plug after an in-cylinder flow or exist around an electrode of the spark plug in a time when the air-fuel mixture keeps an easy combustion state; and ignition is made by the spark plug at timing when the air-fuel mixture of the easy combustion state reaches the electrode of the spark plug or timing when the air-fuel mixture exists around the electrode of the spark plug. Otherwise, easy ignitibility of the air-fuel mixture is not sufficient even in the case of processing by the non-thermal plasma, and stable ignition of a lean/dilution air-fuel mixture is impossible.

Therefore, a spark discharge ignition promoting method and a spark discharge ignition promoting apparatus generates non-thermal plasma in a cylinder by a non-thermal plasma generating unit; provides the non-thermal plasma generating unit at a location where the processed air-fuel mixture by the non-thermal plasma reaches a spark plug after an in-cylinder flow or where the air-fuel mixture exists around an electrode of the spark plug in a time when the air-fuel mixture keeps an easy combustion state; and ignites by discharge of the spark plug at timing when the processed air-fuel mixture by the non-thermal plasma of an easy combustion state reaches the spark plug after an in-cylinder flow or timing when the air-fuel mixture of the easy combustion state exists around an electrode of the spark plug in the time when the air-fuel mixture keeps the easy combustion state.

(2) In a time from a compressing process for the air-fuel mixture to ignition by the spark plug, it is hardly possible for the air-fuel mixture to move by a distance of a half or lower of a cylinder radius in the in-cylinder flow.

Therefore, the spark discharge ignition promoting method and the spark discharge ignition promoting apparatus are required so that a location where the non-thermal plasma is generated is the half or lower of the cylinder radius from the spark plug.

(3) In a case where an area in the cylinder in which the non-thermal plasma is generated by the non-thermal plasma generating unit is smaller than 1 cm², an effect of non-thermal plasma treatment becomes insufficient. On the other hand, in a case where the area in the cylinder in which the non-thermal plasma is generated by the non-thermal plasma generating unit exceeds 10 cm², an easy combustion region becomes too wide, whereby there is a risk that abnormal combustion occurs.

Therefore, the spark discharge ignition promoting method and the spark discharge ignition promoting apparatus are required so that the area in the cylinder in which the non-thermal plasma is generated is from 1 cm² or more to 10 cm².

(4) In a normal engine with only a spark plug, an in-cylinder flow is a flow that occurs by means of a piston motion until a mixed gas in the compressing process is caused to ignite (by the spark plug). Part of the air-fuel mixture is subjected to the non-thermal plasma treatment until the mixed gas in the compressing process is caused to ignite (by the spark plug). Therefore, a flow by a non-thermal plasma induced flow also occurs.

Therefore, the in-cylinder flow is a flow that occurs by means of the piston motion and/or the non-thermal plasma induced flow until the mixed gas in the compressing process is caused to ignite (by the spark plug). Generally, the in-cylinder flow can technologically be grasped by measurement, or can be predicted even by computer simulation to an extent.

(5) In an air-fuel mixture in a cylinder of a gasoline engine, radicals and the like are generated immediately after non-thermal plasma is generated in non-thermal plasma treatment. Then, reaction proceeds from the radicals in a time of about 10 microseconds to generate partial oxides, whereby a region with a combustible state is generated.

It is desirable that the easy combustion state suitable for ignition by the spark plug has a time of 0.1 ms or longer for the ignition by the spark plug. On the other hand, metastable chemical species thus formed such as the partial oxides have a life of several seconds, and an easy combustion characteristic is lost. Therefore, it is necessary that a time for the ignition by the spark plug is no longer than 20 ms since the non-thermal plasma was generated.

Namely, the spark discharge ignition promoting method and the spark discharge ignition promoting apparatus are required so that as timing to ignite by the spark plug in the time when the processed air-fuel mixture by the non-thermal plasma keeps the easy combustion state, the time of plug ignition is from 0.1 ms or more to 20 ms since the non-thermal plasma is generated.

An ignition apparatus has a location relationship with an engine body, a size relationship, and a relationship between an operation of the non-thermal plasma generating unit and an operation of the spark plug timing in addition to a location relationship between the non-thermal plasma generating unit and the spark plug. Therefore, effects as an engine with the spark discharge ignition promoting apparatus are exerted.

Hereinafter, embodiments will be described in detail.

### First Embodiment

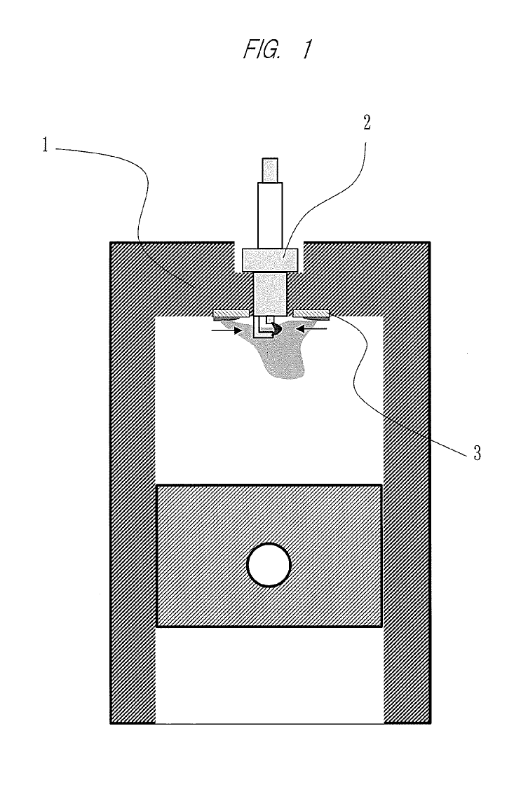

FIG. 1 shows the whole configuration according to the first embodiment. A spark plug 2 is mounted on a cylinder head 1. An ignition promoting apparatus 3 is installed around the spark plug 2. The ignition promoting apparatus 3 is configured to generate an induced flow with discharge of non-thermal plasma. In the first embodiment, an electrode of non-thermal plasma generating means is provided along a surface of the inside of a cylinder. Therefore, it is a configuration in which a size of an area in which the non-thermal plasma is generated is flexibly set and easily installed on the cylinder surface.

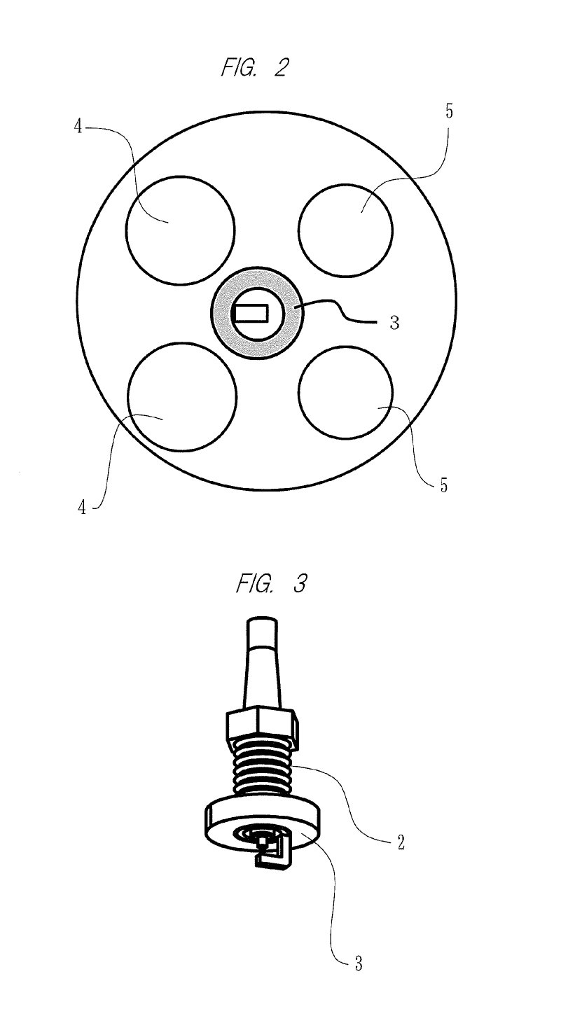

FIG. 2 is a view of the cylinder head 1 when viewed from a combustion chamber side. In the present embodiment, the spark plug 2 is arranged at a central portion that is encircled by intake valves 4 and exhaust valves 5.

In this regard, a fuel supplying method may be either a port injection method or a direct injection method.

FIG. 3 shows a relationship between the spark plug 2 and the ignition promoting apparatus 3. They are arranged so that a central electrode and an earth electrode of the spark plug 2 protrude from an opening of the ignition promoting apparatus 3 which is annular.

The spark plug 2 is screwed to a plug hole formed in the cylinder head 1 in the similar manner to that of a conventional engine.

As shown in FIG. 1, a concave portion is formed along a circumference of the plug hole on a combustion chamber side wall surface of the cylinder head 1. The annular ignition promoting apparatus 3 is fitted into this concave portion so as not to cause a step in the combustion chamber, whereby no influence is applied to a shape of the combustion chamber.

In this regard, it is desirable that the ignition promoting apparatus 3 is installed at an upstream side in a case where an extremely fast flow is formed in the vicinity of the plug by adopting a special combustion chamber shape.

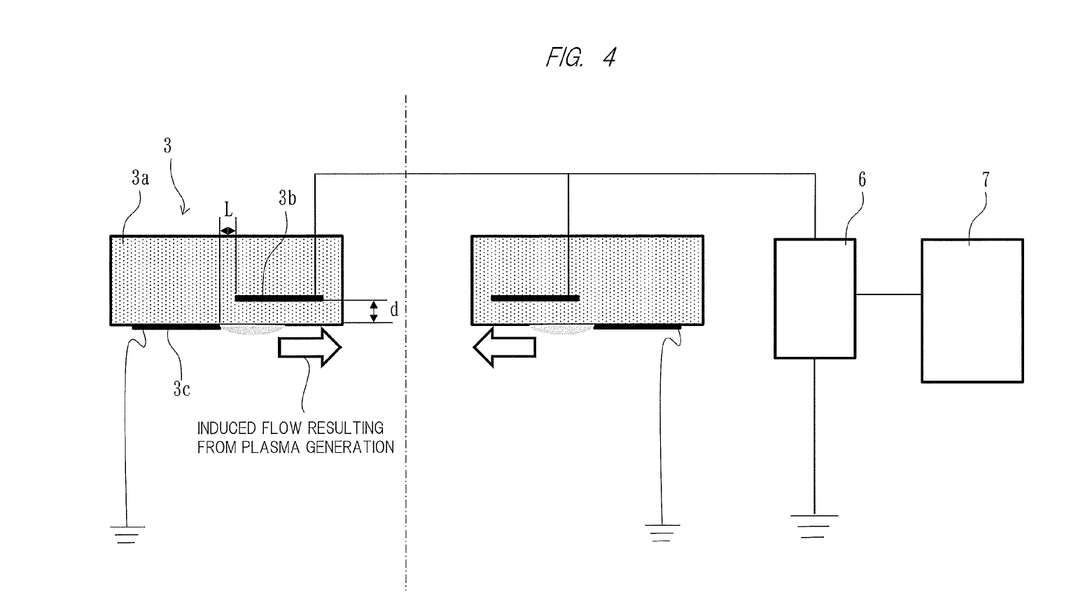

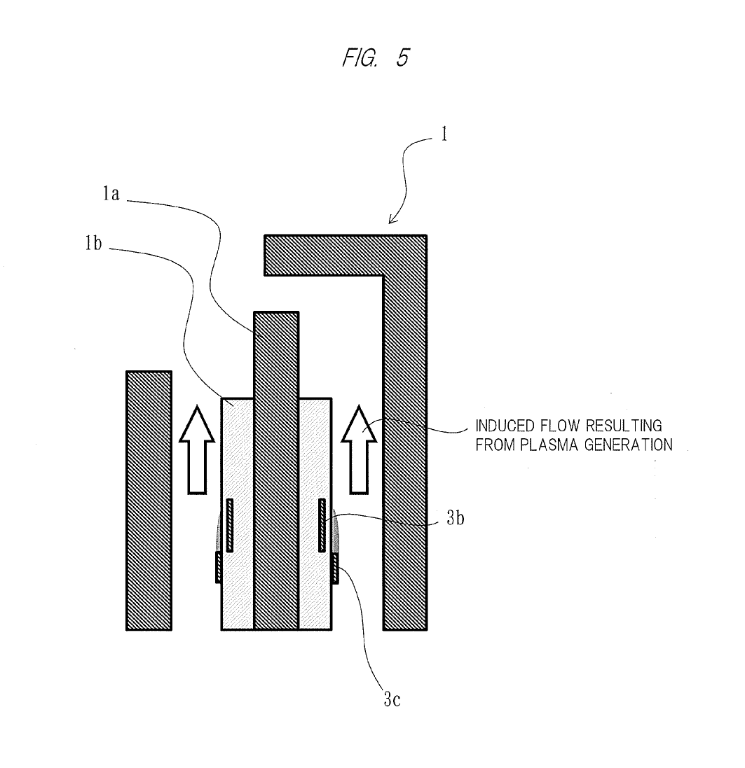

FIG. 4 is a view showing a cross-section drawing and electric connection of the ignition promoting apparatus 3. An annular embedded electrode 3b is also embedded in an annular dielectric 3a, which is molded from a material with high durability against combustion chamber temperature, such as alumina ceramic, sapphire and the like. The electrode 3b is arranged substantially parallel at a location of a depth d (from about several hundred microns to several millimeters) from a bottom surface of the dielectric 3a which faces the combustion chamber.

On the other hand, an exposed electrode 3c is mounted on the combustion chamber side bottom surface of the annular dielectric 3a facing the combustion chamber and at a circumferential side of the embedded electrode 3b so as to be separated in a radius direction by a distance L (from 0 to about several millimeters). In this regard, the embedded electrode 3b may also be formed by a material having high durability against the combustion chamber temperature and some degree of conductivity, such as a metal or the like that is used for the central electrode of the spark plug, and may form an earth electrode via a cylinder block. The cylinder block itself may be used as the exposed electrode.

When an alternating high RF voltage is applied to the embedded electrode 3b by a pulse voltage applying apparatus 6, non-thermal plasma resulting from discharge is generated between the grounded exposed electrode 3c and the embedded electrode 3b and under the embedded electrode 3b in the combustion chamber, whereby radicals, ions, partial oxides and the like are generated in premixed fuel that passes through the non-thermal plasma. Further, rapid rise of temperature is caused due to the ions formed in the non-thermal plasma and/or energy relaxation of an excited state. This premixed fuel flows in a direction of an arrow by means of an induced flow resulting from plasma generation, that is, from a circumferential side of the combustion chamber toward a central portion of the combustion chamber. For this reason, an air-fuel mixture containing radicals and partial oxides with a high concentration gathers around the spark plug. When discharge occurs by the spark plug, the air-fuel mixture starts combustion from this point, and the combustion propagates toward the circumferential side of the combustion chamber.

Herewith, the combustion is carried out smoothly all over the combustion chamber without generating knocking or misfire even in the case of a super lean air-fuel mixture. In this regard, as will be described later, timing of the high RF voltage applied to the embedded electrode 3b, a voltage value, and an applied time of the pulse voltage applying apparatus 6 are controlled by a control device 7 that works together with an ignition timing control device.

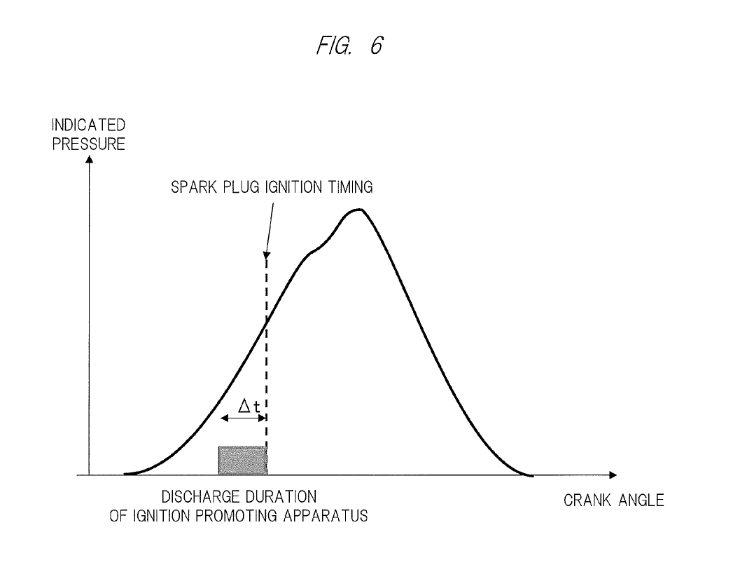

FIG. 6 shows a relationship of ignition timing of the spark plug, discharge timing by the ignition promoting apparatus 3, and discharge duration. Basically, discharge by the ignition promoting apparatus 3 is started from Δt before the ignition timing of the spark plug, and the discharge is terminated at the ignition timing, whereby an induced flow is formed around the spark plug at the ignition timing.

For example, when the number of revolutions of the engine is 1,200 rpm, the discharge is started from 10° before a top dead center of a crank angle. When the number of revolutions is 2,400 rpm, the discharge is started from 20° before the top dead center of the crank angle. About 1 ms is ensured as the discharge duration.

The engine with the spark discharge ignition promoting apparatus according to the first embodiment has the configuration described above. Therefore, the effects of promotion of the ignition by the spark discharge ignition promoting apparatus can be exerted even in the case of a lean or super lean air-fuel mixture, and it is possible to ignite surely and stably.

Further, the non-thermal plasma generating means merely acts on promotion of the ignition by the spark plug. Therefore, it is possible to ignite with energy saving without supplying particularly high electric power.

Therefore, a load on the electrodes and the like for generating plasma can be made smaller; a life of the apparatus is made longer; and there is no need to make it including a power source thereof larger. Therefore, it is possible to realize the apparatus at low cost.

### First Comparative Example

In a case where the engine according to the first embodiment is operated without activating the non-thermal plasma generating means, it becomes an operation based on ignition of only the spark plug, and is the similar operation to that of a conventional engine.

In a case where an air-fuel mixture used for the operation is caused to become lean or super lean, the ignition by only the spark plug cannot be carried out stably, whereby the operation becomes impossible.

### Second Comparative Example

Japanese Patent Application No. 2015-542682 as the prior art by the inventors of the present application discloses a configuration of a conventional internal-combustion engine for a premixing combustion method in which a spark plug is provided in a combustion chamber of a cylinder and a non-thermal equilibrium plasma generating apparatus is further provided in an air-fuel mixture supplying system to an intake port.

In a case where a lean or super lean air-fuel mixture is used for the engine according to the second comparative example, ease of ignition is improved compared with the conventional engine according to the first comparative example. However, the ignition is not stabilized, and it may become inoperable in the case of super lean or super dilution.

Compared with the first embodiment, in the configuration of the engine according to second comparative example, a route of the flow of the air-fuel mixture during the processes from non-thermal plasma treatment in the air-fuel mixture supplying system to ignition (by the spark plug), including intake and compression, in the cylinder is long. Thus, the air-fuel mixture that is subjected to non-thermal plasma treatment in the air-fuel mixture supplying system advances mixture with an air-fuel mixture that is not subjected to the non-thermal plasma treatment and diffusion, whereby an easy combustion characteristic is easily lost.

In order to stabilize an operation (ignition) of the engine according to the second comparative example even in the case of the lean or super lean air-fuel mixture, it is necessary to make a volume percent of the air-fuel mixture, which is to be subjected to the non-thermal plasma treatment, larger.

Namely, in order to facilitate ignition of the lean air-fuel mixture, reforming by plasma must be carried out over a large volume so that the partial oxides and the like described above with a prescribed concentration are contained in almost of the intake air-fuel mixture.

Therefore, the engine according to the second comparative example requires large non-thermal plasma generating means and a large power source configured to supply electric power thereto. However, since they generate a large amount of air-fuel mixture of an easy combustion state for intake, abnormal combustion may occur at timing before the ignition by the spark plug, whereby a risk such as knocking is increased.

### Second Embodiment

FIG. 5 shows a configuration of a second embodiment. In the second embodiment, by embedding an annular embedded electrode 3b in an insulator through which a central electrode of a spark plug 1 goes and fitting the annular exposed electrode 3c to an outer surface of the insulator, an induced flow resulting from plasma generation is injected toward the inside of a combustion chamber from a space formed between an outer circumference of the insulator and the grounded electrode.

In order to gain a ratio of a thermal plasma generating area in the cylinder, it is necessary to thicken and/or lengthen an electrically insulating tube member integrated with a plug around the plug, which is made of ceramic. However, installation to an engine cylinder is substantially similar to that of a conventional spark plug. It is easy to install and exchange it, and it is a configuration easy for maintenance.

As described above, the invention made by the inventors of the present application has been explained specifically on the basis of the embodiments. However, it goes without saying that the present invention is not limited to the embodiments, and the present invention may be modified into various forms without departing from the substance thereof.

### Reference: Experiment for Examining Effects of Non-Thermal Plasma Treatment Against Air-Fuel Mixture

Hereinafter, an experiment for examining effects of non-thermal plasma treatment against an air-fuel mixture according to the present invention will be described.

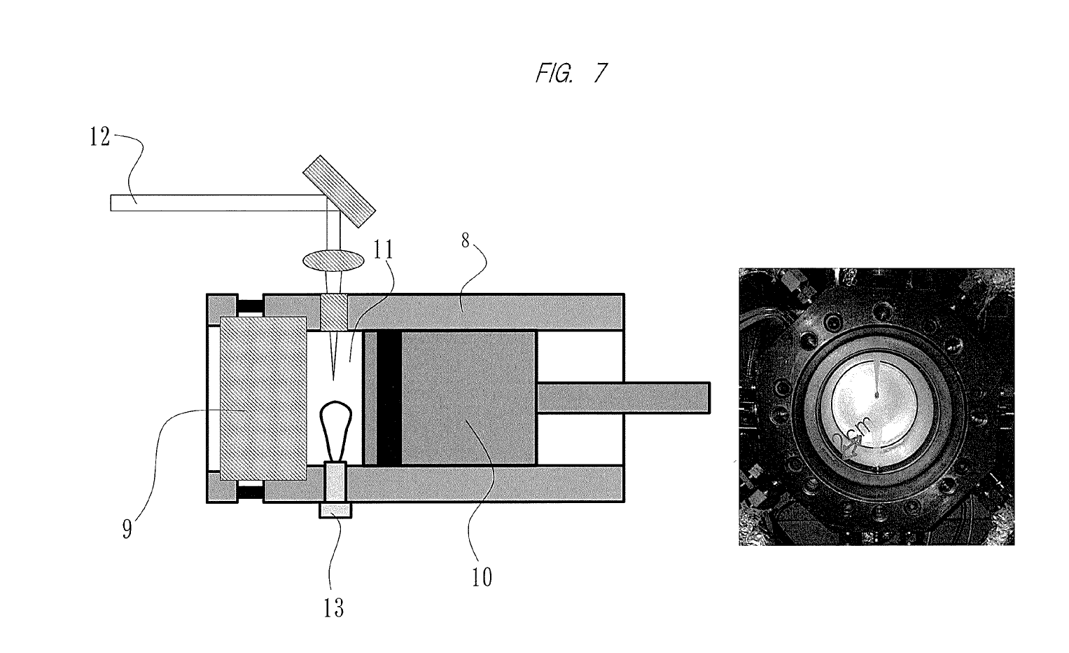

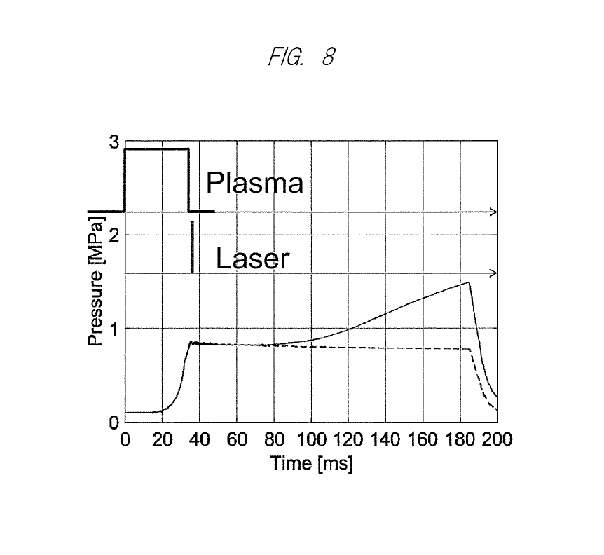

FIG. 7 shows an outline of experimental equipment. In order to visualize a state to arrive from ignition to combustion, a transparent quartz window 9 is mounted on one end of a rapid compression expansion machine (RCEM) liner 8. A combustion chamber 11 is formed by an RCEM piston 10 that is configured to slide in the RCEM liner 8, whereby an air-fuel mixture therein is compressed. Pulse YAG laser light 12 is concentrated from an upper portion of the combustion chamber 11, and breakdown is formed at a center in the combustion chamber 11, thereby igniting. At this time, fuel was isooctane, an equivalence ratio was 0.5, a compression ratio was 5.5, and compression duration of the piston was equivalent to that when an engine is operated at 1,200 rpm. As a reactor 13 for generating non-thermal plasma, a commercially available spark plug is modified in order to cause an induced flow to reach a laser breakdown location. A plasma actuator that forms a jet-like induced jet flow vertically from the plasma actuator was used. An applied voltage Vpp was 7.8 kV (from a peak to a next peak of alternating voltage), and an applied time was 36 ms until ignition timing by the pulse YAG laser light 12.

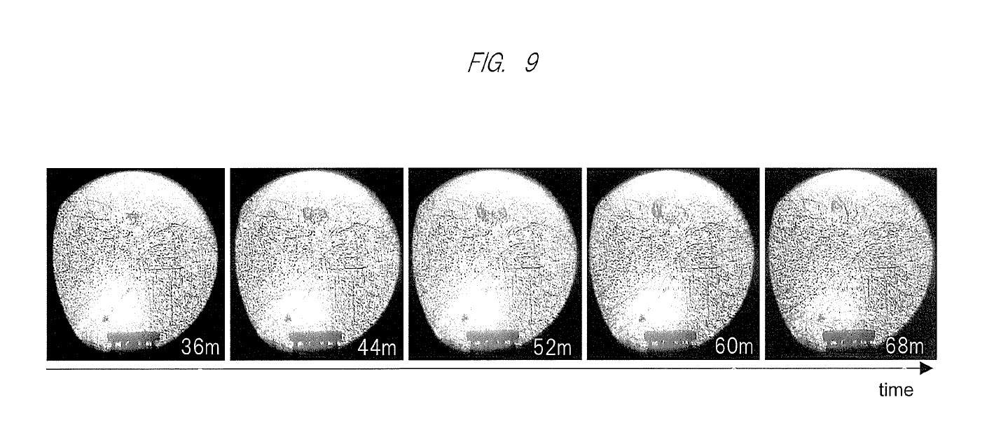

FIG. 8 shows a pressure history. In a case where the reactor 13 is not operated, pressure after 40 ms elapses becomes flat as shown by a broken line. On the other hand, in a case where the reactor 13 is operated, the pressure raises up to 180 ms as shown by a solid line. Thus, it is possible to confirm that ignition and combustion are generated.

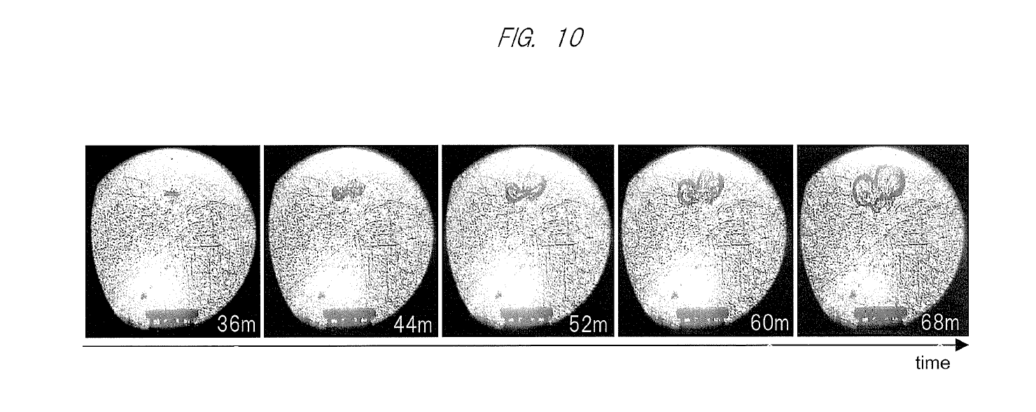

FIG. 9 and FIG. 10 show results of Schlieren measurement that are photographed every 4 ms through the quartz window 9, and respectively show, in the same operating condition, the case where the reactor 13 of the ignition promoting apparatus 3 is not operated and the case where the reactor 13 is operated.

As is apparent by comparing both drawings, when the reactor 13 is not operated, a flame hardly propagates and misfire occurs in a flow of a compression end. However, when the reactor 13 is operated, ignition is succeeded, and it is possible to confirm that the flame propagates to the air-fuel mixture in the combustion chamber.

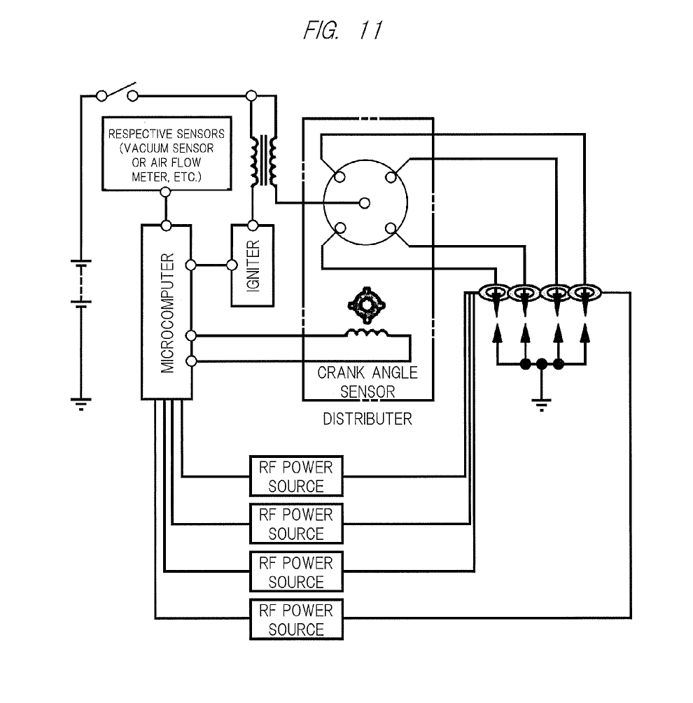

FIG. 11 shows the whole configuration in a case where the ignition promoting apparatus 3 is mounted in a four-cylinder engine. A control device 7 is configured by a microcomputer that is used to control the ignition timing, and controls an optimal voltage value of the high RF voltage to the embedded electrode 3b and application start timing in accordance with the number of revolutions on the basis of detection of a crank angle sensor by using the ignition timing as termination timing.

Further, it is necessary to increase the induced flow rate when the number of revolutions is high. For this reason, it is effective to adopt a control in which a voltage value of the high RF voltage becomes higher in accordance with an increase in the number of revolutions of the engine. Further, when the ignition is stabilized under a high engine load or the like, activation of the ignition promoting apparatus 3 may be stopped.

In this regard, electric power required to generate non-thermal plasma by applying the high RF voltage to the embedded electrode 3b is about 3 W. When an applied time width is 15 ms and the number of revolutions is 2,400 rpm, average power is about 1 W. Thus, it is substantially ignorable in view of an output of the engine.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1-14. (canceled)

15. An ignition promoting method for an engine that uses premixed fuel, the method comprising:
generating non-thermal plasma around a spark plug or in a region including the spark plug in a cylinder in a compressing process of the engine by a non-thermal plasma generating unit to process an air-fuel mixture, the non-thermal plasma generating unit including an embedded electrode embedded in a dielectric and an exposed electrode that faces the embedded electrode; and
igniting, by discharge of the spark plug, an air-fuel mixture processed by the generated non-thermal plasma at timing when the air-fuel mixture reaches the spark plug by an in-cylinder flow or timing when the air-fuel mixture exists in a region including an electrode of the spark plug in a time when the air-fuel mixture keeps an easy combustion state.

16. The ignition promoting method according to claim 15,
wherein each of the embedded electrode and the exposed electrode has an annular shape and is arranged so as to surround the spark plug, and the exposed electrode has an inner diameter larger than an outer diameter of the embedded electrode.

17. The ignition promoting method according to claim 15,
wherein the non-thermal plasma generating unit is arranged within a half or lower of a cylinder radius from the spark plug.

18. The ignition promoting method according to claim 15,
wherein the non-thermal plasma generating unit is configured to set an area in which the non-thermal plasma is generated to from 1 cm² or more to 10 cm².

19. The ignition promoting method according to claim 15,
wherein the in-cylinder flow is a flow by a piston motion and/or a non-thermal plasma induced flow.

20. The ignition promoting method according to claim 15,
wherein a time from generation of the non-thermal plasma to plug ignition is from 0.1 ms or more to 20 ms.

21. An ignition promoting apparatus comprising:
a non-thermal plasma generating unit provided in a cylinder and configured to generate non-thermal plasma and process an air-fuel mixture of premixed fuel by the non-thermal plasma to form an air-fuel mixture of an easy combustion state, the non-thermal plasma generating unit including an embedded electrode embedded in a dielectric and an exposed electrode that faces the embedded electrode; and
a spark plug fitted to the cylinder and configured to ignite the air-fuel mixture of the easy combustion state by discharge of the spark plug,
wherein the non-thermal plasma generating unit is arranged at a location where the air-fuel mixture is configured to reach the spark plug by an in-cylinder flow or where the air-fuel mixture is configured to include an electrode of the spark plug in a time when the air-fuel mixture keeps the easy combustion state.

22. The ignition promoting apparatus according to claim 21,
wherein each of the embedded electrode and the exposed electrode has an annular shape and is arranged so as to surround the spark plug, and the exposed electrode has an inner diameter larger than an outer diameter of the embedded electrode.

23. The ignition promoting apparatus according to claim 22,
wherein the exposed electrode of the non-thermal plasma generating unit is grounded via a cylinder head and a cylinder block, and a high RF voltage is applied to the embedded electrode.

24. The ignition promoting apparatus according to claim 21,
wherein the exposed electrode of the non-thermal plasma generating unit is grounded via a cylinder head and a cylinder block, and a high RF voltage is applied to the embedded electrode.

25. The ignition promoting apparatus according to claim 21,
wherein the non-thermal plasma generating unit is arranged within a half or lower of a cylinder radius from the spark plug.

26. The ignition promoting apparatus according to claim 21,
wherein the non-thermal plasma generating unit is configured to set an area in which the non-thermal plasma is generated to from 1 cm² or more to 10 cm².

27. The ignition promoting apparatus according to claim 21,
wherein the in-cylinder flow is a flow by a piston motion and/or a non-thermal plasma induced flow.

28. The ignition promoting apparatus according to claim 21,
wherein a time from when the non-thermal plasma generating unit generates the non-thermal plasma to when the spark plug ignites the air-fuel mixture is from 0.1 ms or more to 20 ms.

29. The ignition promoting apparatus according to claim 21,
wherein the non-thermal plasma is generated by applying a high RF voltage between the embedded electrode and the exposed electrode.

30. An engine comprising:
a cylinder;
a non-thermal plasma generating unit provided in the cylinder and configured to generate non-thermal plasma and process an air-fuel mixture of premixed fuel by the non-thermal plasma to form an air-fuel mixture of an easy combustion state, the non-thermal plasma generating unit including an embedded electrode embedded in a dielectric and an exposed electrode that faces the embedded electrode; and
a spark plug fitted to the cylinder and configured to ignite the air-fuel mixture of the easy combustion state by discharge,
wherein the non-thermal plasma generating unit is arranged at a location where the air-fuel mixture is configured to reach the spark plug by an in-cylinder flow or where the air-fuel mixture is configured to include an electrode of the spark plug in a time when the air-fuel mixture keeps the easy combustion state.

31. The engine according to claim 30,
wherein each of the embedded electrode and the exposed electrode has an annular shape and is arranged so as to surround the spark plug, and the exposed electrode has an inner diameter larger than an outer diameter of the embedded electrode.

32. The engine according to claim 30,
wherein the exposed electrode of the non-thermal plasma generating unit is grounded via a cylinder head and a cylinder block, and a high RF voltage is applied to the embedded electrode.

33. The engine according to claim 30,
wherein the exposed electrode of the non-thermal plasma generating unit is grounded via a cylinder head and a cylinder block, and a high RF voltage is applied to the embedded electrode.

34. The engine according to claim 30,
wherein the non-thermal plasma is generated by applying a high RF voltage between the embedded electrode and the exposed electrode.
